(19) United States
(12) Patent Application Publication
(10) Pub. No.: US 2013/0000671 A1
(43) Pub. Date: Jan. 3, 2013

(54) SUBSTRATE CLEANING METHOD

(76) Inventors: Xinming WANG, Tokyo (JP); Kunimasa Matsushita, Tokyo (JP); Fumitoshi Oikawa, Tokyo (JP)

(21) Appl. No.: 13/527,857

(22) Filed: Jun. 20, 2012

(30) Foreign Application Priority Data
Jun. 30, 2011 (JP) 2011-145124

(51) Int. Cl. B08B 1/04

(52) U.S. Cl. 134/6

(57) ABSTRACT

A substrate cleaning method is provided, which can clean a surface of a substrate with a roll cleaning member more uniformly over the entire surface even when a point (area) exists in the cleaning area of the surface of the substrate at which the relative speed between the rotational speed of the substrate and the rotational speed of the roll cleaning member is zero. The substrate cleaning method for scrubbing a surface of a substrate with a roll cleaning member, extending along the diametrical direction of the substrate, by rotating the substrate and the roll cleaning member while keeping the roll cleaning member in contact with the surface of the substrate, includes changing a rotational speed of at least one of the substrate and the roll cleaning member or a direction of rotation of the substrate during the scrub cleaning of the surface of the substrate.

### CROSS REFERENCE TO RELATED APPLICATIONS

This document claims priority to Japanese Application Number 2011-145124, filed Jun. 30, 2011, the entire contents of which are hereby incorporated by reference.

### BACKGROUND OF THE INVENTION

1. Field of the Invention

The present invention relates to a substrate cleaning method for scrubbing a surface of a substrate, such as a semiconductor wafer, with a long cylindrical roll cleaning member by rotating the substrate and the roll cleaning member while keeping the roll cleaning member in contact with the surface of the substrate in the presence of a cleaning liquid. The substrate cleaning method of the present invention can be applied to cleaning of a surface of a semiconductor wafer, or to cleaning of a surface of a substrate in the manufacturing of an LCD (liquid crystal display) device, a PDP (plasma display panel) device, a CMOS image sensor, etc.

2. Description of the Related Art

In a damascene interconnect forming process for forming interconnects in a surface of a substrate by filling a metal into interconnect trenches formed in an insulating film in the surface of the substrate, an extra metal on the surface of the substrate is polished away by performing chemical mechanical polishing (CMP) after the formation of damascene interconnects. A slurry, remaining after its use in CMP, metal polishing debris, etc. are present on the surface of the substrate after CMP. Such residues, remaining on the surface of the substrate after CMP, therefore, need to be cleaned off.

As a cleaning method for cleaning a surface of a substrate after CMP, a scrub cleaning method is known which comprises scrubbing the surface of the substrate with a long cylindrical roll cleaning member (roll sponge or roll brush) by rotating the substrate and the roll cleaning member while keeping the roll cleaning member in contact with the surface of the substrate in the presence of a cleaning liquid (see Japanese Patent Laid-Open Publication No. H10-308374). A roll cleaning member for use in such scrub cleaning generally has a length which is somewhat larger than the diameter of a substrate, and is disposed in a position perpendicular to the rotational axis of the substrate in a cleaning area which is a contact cleaning surface. The surface of the substrate can be cleaned by rubbing the surface of the substrate with the roll cleaning member, i.e., by rotating the substrate on the rotational axis while keeping the roll cleaning member in contact with the surface of the substrate over the entire length in the diametrical direction.

### SUMMARY OF THE INVENTION

As shown in FIG. 1, consider now the case where a surface of a substrate W is cleaned by rotating the substrate W, having a diameter D_{W}, on its rotational axis O_{W} at a rotational speed N_{W} (angular velocity ω_{W}) and rotating a roll cleaning member R, having a diameter D_{R}, on its rotational axis O_{R} at a rotational speed N_{R} (angular velocity ω_{R}) while keeping the roll cleaning member R in contact with the surface of the substrate over the entire length of the diameter D_{W} of the substrate W in the presence of a cleaning liquid. In this case, scrub cleaning of the substrate W is performed in a position along a linearly-extending cleaning area (contact area) C of the surface of the substrate W with the roll cleaning member R.

The rotational speed V_{W} of a point, lying on the surface of the substrate W in the cleaning area C and on a circle around the rotational axis O_{W} as the center, having a diameter Do, is proportional to the radius (Do/2) from the rotational axis O_{W}, as follows:

V_{W}=(Do/2)·ω_{W}=(Do/2)·2πN_{W}

The rotational speed V_{R} of the peripheral surface of the roll cleaning member R is constant along the length direction of the cleaning area C, i.e., regardless of the radius (Do/2) from the rotational axis O_{W}, as follows:

V_{R}=(D_{R}/2)·ω_{R}=(D_{R}/2)·2πN_{R}

The rotational speed V_{W} of the substrate W is equal to the rotational speed V_{R} of the roll cleaning member R (V_{W}=V_{R}) when Do=D_{R}·(N_{R}/N_{W}). Thus, the relative speed between them is zero when the substrate W and the roll cleaning member R are rotating in the same direction at the point in the cleaning area (contact area) C.

For example, when scrub cleaning of a surface of a substrate (wafer) W, having a diameter of 300 mm, is carried out by a roll cleaning member R, having a diameter of 60 mm, while rotating the substrate W at a rotational speed of 150 rpm and rotating the roll cleaning member R at 200 rpm (cleaning conditions A), the diameter Do of a circle on the surface of the substrate W around the rotational axis O_{W} as the center, passing that point in the cleaning area at which the relative speed between the rotational speed V_{W} of the substrate W and the rotational speed V_{R} of the roll cleaning member R is zero, is 80 mm (Do=80 mm). If the rotational speed of the 300-mm substrate (wafer) W is decreased to 55 rpm (cleaning conditions B) under otherwise the same conditions, the diameter Do of a circle on the surface of the substrate W around the rotational axis O_{W} as the center, passing that point in the cleaning area at which the relative speed between the rotational speed V_{W} of the substrate W and the rotational speed V_{R} of the roll cleaning member R is zero, is 218 mm (Do=218 mm).

When the surface of the substrate is cleaned under the above-described cleaning conditions A, the cleaning performance is poor and particles (defects) are likely to remain in an area along the circle having a diameter of 80 mm (Do=80 mm) on the surface of the substrate, as shown in FIG. 2A. When the surface of the substrate is cleaned under the above-described cleaning conditions B, the cleaning performance is poor and particles (defects) are likely to remain in an area along the circle having a diameter of 218 mm (Do=218 mm) on the surface of the substrate, as shown in FIG. 2B.

It is considered in this regard that contamination, which lowers the cleaning performance, will occur in an area (contaminated area Po) of the roll cleaning member R which lies at that point and its vicinity in the cleaning area C at which the relative speed between the rotational speed V_{W} of the substrate W and the rotational speed V_{R} of the roll cleaning member R is zero. It is also considered that reverse contamination of the substrate W from the contaminated area Po will occur when detaching the roll cleaning member R from the substrate W.

When a surface of a substrate (wafer) having a diameter of 300 mm or 450 mm, rotating at a speed of 5 to 200 rpm, is scrubbed with a roll cleaning member having a diameter of about 30 to 80 mm, rotating at a speed of 10 to 200 rpm, for example, a point (area) often exists in the cleaning area of the surface of the substrate at which the relative speed between the rotational speed of the substrate and the rotational speed of the roll cleaning member is zero.

The following countermeasures can avoid the presence of a point (area) in the cleaning area of a surface of a substrate at which the relative speed between the rotational speed of the substrate and the rotational speed of the roll cleaning member is zero: In the case of scrub cleaning of a substrate having a diameter of 300 mm with a roll cleaning member having a diameter of 60 mm, (1) the rotational speed N_{R} of the roll cleaning member is made at least five times higher than the rotational speed N_{W} of the substrate, or (2) when the roll cleaning member is rotated at a normal speed, e.g., 150 rpm, the substrate is rotated at a low speed, e.g., not more than 30 rpm.

If the roll cleaning member is used continuously over a long period at a rotational speed N_{R} which is at least five times higher than the rotational speed N_{W} of the substrate, there is a considerable risk of breakage of the roll cleaning member due to the generation of heat. On the other hand, if the substrate is rotated at a low speed of not more than 30 rpm, a cleaning liquid, which has been supplied to the surface of the substrate, does not flow smoothly along the surface of the substrate, and particles, etc. are likely to re-adhere to the surface of the substrate, resulting in poor cleaning performance.

The present invention has been made in view of the above situation. It is therefore an object of the present invention to provide a substrate cleaning method which can clean a surface of a substrate with a roll cleaning member more uniformly over an entire surface even when a point (area) exists in a cleaning area of the surface of the substrate at which the relative speed between the rotational speed of the substrate and the rotational speed of the roll cleaning member is zero.

In order to achieve the above object, the present invention provides a substrate cleaning method for scrubbing a surface of a substrate with a roll cleaning member, extending along the diametrical direction of the substrate, by rotating the substrate and the roll cleaning member while keeping the roll cleaning member in contact with the surface of the substrate. This method comprises changing a rotational speed of at least one of the substrate and the roll cleaning member or a direction of rotation of the substrate during the scrub cleaning of the surface of the substrate.

The position of a point (area) in the diametrically-extending cleaning area of the surface of the substrate at which the relative speed between the rotational speed of the substrate and the rotational speed of the roll cleaning member is zero, can be changed by changing, during the scrub cleaning of the surface of the substrate, the rotational speed of at least one of the substrate and the roll cleaning member or the direction of rotation of the substrate. This can reduce concentration of contamination in a particular area of the roll cleaning member and thereby reduce reverse contamination of the substrate from the roll cleaning member, making it possible to clean the surface of the substrate more uniformly over the entire surface.

In a preferred aspect of the present invention, the rotational speed of at least one of the substrate and the roll cleaning member or the direction of rotation of the substrate is changed immediately before the end of scrub cleaning of the surface of the substrate.

The expression “immediately before the end of scrub cleaning of the surface of the substrate” herein refers to, e.g., a point when about 90 percent of the processing time required for scrub cleaning of the surface of the substrate has elapsed. By thus changing the rotational speed of at least one of the substrate and the roll cleaning member or the direction of rotation of the substrate immediately before the end of scrub cleaning of the surface of the substrate, the surface of the substrate can be scrubbed and cleaned for a long time under optimal cleaning conditions while reducing contamination transfer to the substrate due to concentrated contamination in a particular area of the roll cleaning member. In general, the cleaning performance is poor because of insufficient contact between the roll cleaning member and the surface of the substrate, and contamination transfer from the roll cleaning member to the surface of the substrate is most likely to occur at the moment when the roll cleaning member is raised from the surface of the substrate.

In a preferred aspect of the present invention, the rotational speed of at least one of the substrate and the roll cleaning member is changed stepwise or continuously.

By thus stepwise changing the rotational speed of at least one of the substrate and the roll cleaning member, cleaning conditions can be set easily, and the rotational speed of the at least one of the substrate and the roll cleaning member can be easily controlled. By continuously changing the rotational speed of at least one of the substrate and the roll cleaning member, on the other hand, a contaminated area in the roll cleaning member can be more uniformly dispersed.

In a preferred aspect of the present invention, the rotational speed of the substrate and the rotational speed of the roll cleaning member are changed simultaneously during the scrub cleaning of the surface of the substrate.

The optimal combination of the rotational speed of the substrate and the rotational speed of the roll cleaning member may be selected according to the cleaning conditions, etc. in order to maintain the optimal cleaning performance.

The present invention also provides a substrate cleaning method for scrubbing a surface of a substrate with a roll cleaning member, extending along the diametrical direction of the substrate, by rotating the substrate and the roll cleaning member while keeping the roll cleaning member in contact with the surface of the substrate. This method comprises a forward-direction cleaning step of scrubbing a surface of a substrate while rotating the substrate in a forward direction, and an opposite-direction cleaning step of scrubbing a surface of another substrate while rotating the substrate in the opposite direction from the forward direction and at the same rotational speed as in the forward-direction cleaning step. The forward-direction cleaning step and the opposite-direction cleaning step are carried out in an alternate manner and each is repeated for every arbitrary number of successive substrates.

The forward-direction cleaning step and the opposite-direction cleaning step use the same substrate rotational speed, though they differ in the direction of rotation of a substrate. The difference in the substrate rotational direction does not produce any difference in the cleaning performance. Therefore, by alternately repeating the forward-direction cleaning step and the opposite-direction cleaning step for every arbitrary number of successive substrates, it becomes possible to reduce concentration of contamination in a particular area of the roll cleaning member while maintaining a constant cleaning performance for all the substrates.

The every arbitrary number of successive substrates may be every substrate, every one-lot successive substrates, or every predetermined number of successive substrates.

By alternately repeating the forward-direction cleaning step and the opposite-direction cleaning step for every substrate, it becomes possible to reduce concentration of contamination in a particular area of the roll cleaning member while maintaining a constant cleaning performance for all the substrates. By alternately repeating the forward-direction cleaning step and the opposite-direction cleaning step for every one-lot successive substrates, the control software can be simplified. In the case where the forward-direction cleaning step and the opposite-direction cleaning step are alternately repeated for every predetermined number of successive substrates, the number of substrates for which the forward-direction or opposite-direction cleaning step is repeated successively can be determined, e.g., based on contamination of the roll cleaning member. Thus, the flexibility of the cleaning method can be enhanced.

According to the substrate cleaning method of the present invention, the position of a point (area) in the diametrically-extending cleaning area of a surface of a substrate at which the relative speed between the rotational speed of the substrate and the rotational speed of the roll cleaning member is zero, can be changed during scrub cleaning of the surface of the substrate. This can reduce concentration of contamination in a particular area of the roll cleaning member and thereby reduce reverse contamination of the substrate from the roll cleaning member, making it possible to clean the surface of the substrate more uniformly over the entire surface.

### BRIEF DESCRIPTION OF THE DRAWINGS

FIG. 1 is a plan view showing the relationship between a substrate and a roll cleaning member in a scrub cleaning apparatus;

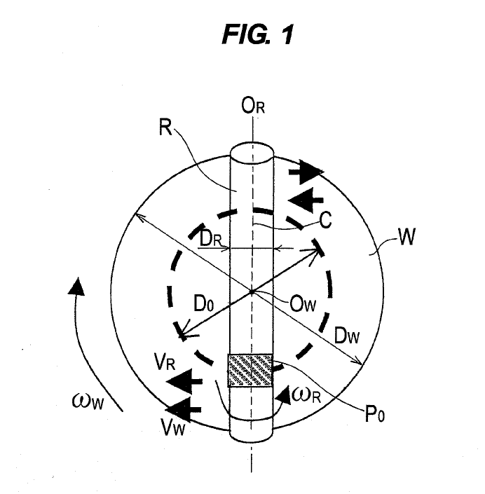

FIGS. 2A and 2B are diagrams showing the distributions of particles (defects) remaining on a surface of a substrate after scrub cleaning performed under different cleaning conditions;

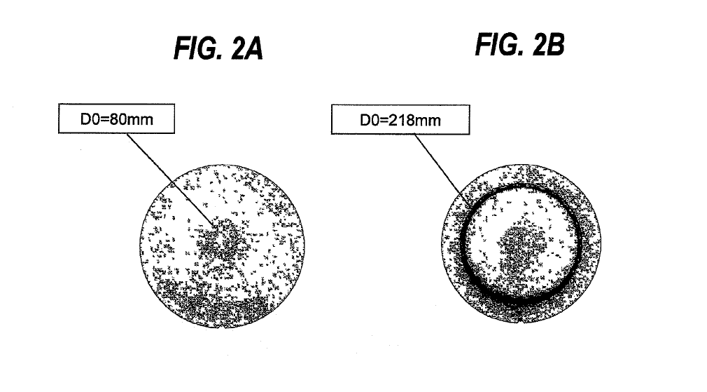

FIG. 3 is a schematic view of an exemplary scrub cleaning apparatus for use in a substrate cleaning method according to the present invention;

FIG. 4 is a plan view showing the relationship between a substrate and a roll cleaning member upon scrub cleaning carried out under cleaning conditions 1;

FIG. 5 is a plan view showing the relationship between a substrate and a roll cleaning member upon scrub cleaning carried out under cleaning conditions 2;

FIG. 6 is a plan view showing the relationship between a substrate and a roll cleaning member upon scrub cleaning carried out under cleaning conditions 3;

FIG. 7 is a plan view showing the relationship between a substrate and a roll cleaning member upon scrub cleaning carried out under cleaning conditions 4; and

FIG. 8 is a graphical diagram showing the number of particles (defects) remaining on a surface of a sample after cleaning in each of Examples 1 and 2, and Comp. Examples 1 and 2, together with the distribution of particles (defects) on the surface of the sample.

### DETAILED DESCRIPTION OF THE PREFERRED EMBODIMENTS

Preferred embodiments of the present invention will now be described with reference to the drawings.

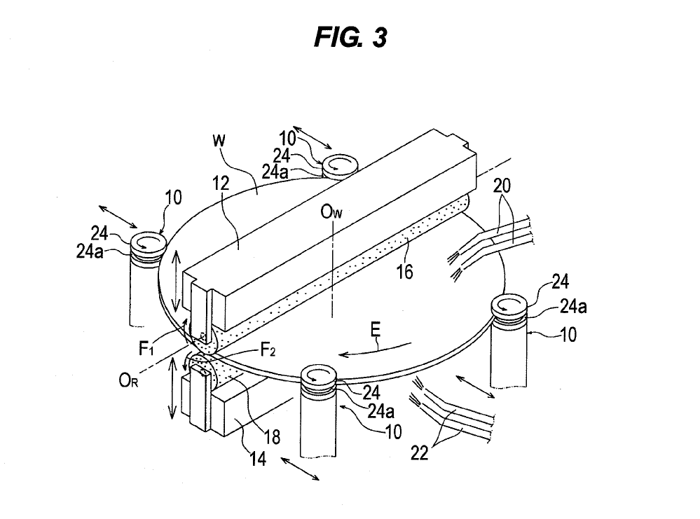

FIG. 3 is a schematic view of an exemplary scrub cleaning apparatus for use in a substrate cleaning method according to the present invention. As shown in FIG. 3, this scrub cleaning apparatus includes a plurality of (e.g., four as illustrated) horizontally movable spindles 10 for supporting a periphery of a substrate W, such as a semiconductor wafer, with its front surface facing upwardly, and horizontally rotating the substrate W, a vertically movable upper roll holder 12 disposed above the substrate W supported and rotated by the spindles 10, and a vertically movable lower roll holder 14 disposed below the substrate W supported and rotated by the spindles 10.

A long cylindrical upper roll cleaning member (roll sponge) 16, e.g., made of PVA, is rotatably supported by the upper roll holder 12. A long cylindrical lower roll cleaning member (roll sponge) 18, e.g., made of PVA, is rotatably supported by the lower roll holder 14. Instead of the roll sponges, e.g., made of PVA, it is possible to use roll brushes, each having a surface brush, as the roll cleaning members 16, 18.

The upper roll holder 12 is coupled to a not-shown drive mechanism for vertically moving the upper roll holder 12 and rotating the upper roll cleaning member 16, rotatably supported by the upper roll holder 12, in the direction shown by the arrow F₁. The lower roll holder 14 is coupled to a not-shown drive mechanism for vertically moving the lower roll holder 14 and rotating the lower roll cleaning member 18, rotatably supported by the lower roll holder 14, in the direction shown by the arrow F₂.

An upper cleaning liquid supply nozzle 20, for supplying a cleaning liquid to a front surface (upper surface) of the substrate W, is disposed above the substrate W supported by the spindles 10, while a lower cleaning liquid supply nozzle 22, for supplying a cleaning liquid to a back surface (lower surface) of the substrate W, is disposed below the substrate W supported by the spindles 10.

A peripheral portion of the substrate W is located in an engagement groove 24a formed in a circumferential surface of a spinning top 24 provided at the top of each spindle 10. By spinning the spinning tops 24 while pressing them inwardly against the peripheral portions of the substrate W, the substrate W is rotated horizontally on the rotational axis O_{W} in the direction shown by the arrow E (or in the opposite direction). In this embodiment, two of the four spinning tops 24 apply a rotational force to the substrate W, while the other two spinning tops 24 each function as a bearing and receive the rotation of the substrate W. It is also possible to couple all the spinning tops 24 to a drive mechanism so that they all apply a rotational force to the substrate W.

While horizontally rotating the substrate W and supplying a cleaning liquid (liquid chemical) from the upper cleaning liquid supply nozzle 20 to the front surface (upper surface) of the substrate W, the upper roll cleaning member 16 is rotated and lowered to bring it into contact with the front surface of the rotating substrate W, thereby scrubbing the front surface of the substrate W with the upper roll cleaning member 16 in the presence of the cleaning liquid to clean the front surface of the substrate W. The length of the upper roll cleaning member 16 is set slightly larger than the diameter of the substrate W. The upper roll cleaning member 16 is disposed in such a position that its central axis (rotational axis) O_{R} is substantially perpendicular to the rotational axis O_{W} of the substrate W, and that it extends over the entire length of the diameter of the substrate W. This enables simultaneous cleaning of the entire front surface of the substrate W.

Simultaneously with the above-described scrub cleaning of the front surface of the substrate W, scrub cleaning of the back surface of the substrate W is carried out in the following manner: While horizontally rotating the substrate W and supplying a cleaning liquid (liquid chemical) from the lower cleaning liquid supply nozzle 22 to the back surface (lower surface) of the substrate W, the lower roll cleaning member 18 is rotated and raised to bring it into contact with the back surface of the rotating substrate W, thereby scrubbing the back surface of the substrate W with the lower roll cleaning member 18 in the presence of the cleaning liquid to clean the back surface of the substrate W. The length of the lower roll cleaning member 18 is set slightly larger than the diameter of the substrate W. As with the above-described cleaning of the front surface of the substrate W, the entire back surface of the substrate W can be cleaned simultaneously.

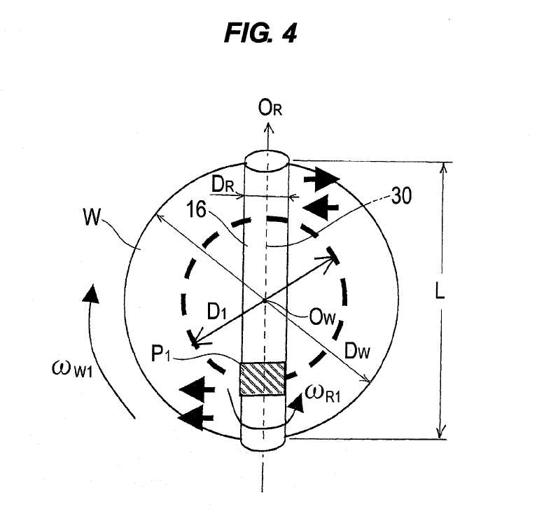

When cleaning the front surface of the substrate W with the upper roll cleaning member (hereinafter simply referred to as “roll cleaning member”) 16 in the above-described manner, the substrate W and the roll cleaning member 16 make contact with each other in a cleaning area 30 having a length L, extending linearly in the axial direction of the roll cleaning member 16 over the entire length of the substrate W in the diametrical direction, as shown in FIG. 4, and the surface of the substrate W is scrubbed and cleaned in the cleaning area 30.

When a front surface of a substrate W having a diameter D_{W} is scrubbed and cleaned with the roll cleaning member 16 having a diameter D_{R} while rotating the substrate W at a rotational speed N_{W1} (angular velocity ω_{W1}) and rotating the roll cleaning member 16 at a rotational speed N_{R1} (angular velocity ω_{R1}), as shown in FIG. 4, this cleaning conditions are referred to as “cleaning conditions 1”. The length L of the cleaning area 30 is substantially equal to the diameter D_{W} of the substrate W.

In scrub cleaning of the surface of the substrate W carried out under the cleaning conditions 1, there may exist a specific point in the cleaning area 30 at which the rotational speed of the substrate W is equal to the rotational speed of the roll cleaning member 16, and the substrate W and the roll cleaning member 16 are rotating in the same direction, i.e., at which the relative speed between them is zero. The diameter of a circle on the surface of the substrate, lying around the rotational axis O_{W} of the substrate W as the center and passing the specific point, is represented by D₁. Contamination will occur partly in the roll cleaning member 16 in a contaminated area P₁ lying in a position corresponding to the specific point, at which the relative speed is zero, and its vicinity in the cleaning area 30.

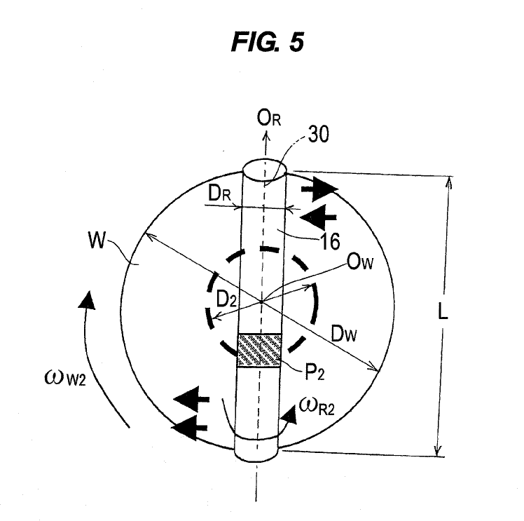

When the surface of the substrate W is cleaned while rotating the substrate W at a rotational speed N_{W2}(>N_{W1}) (angular velocity ω_{W2}(>ω_{W1})) which is higher than the rotational speed N_{W1} (angular velocity ω_{W1}) of the cleaning conditions 1, and/or rotating the roll cleaning member 16 at a rotational speed N_{R2}(<N_{R1}) (angular velocity ω_{R2}(<ω_{R1})) which is lower than the rotational speed N_{R1} (angular velocity ω_{R1}) of the cleaning conditions 1, as shown in FIG. 5, under otherwise the same conditions as the cleaning conditions 1, this cleaning conditions are referred to as “cleaning conditions 2”.

In scrub cleaning of the surface of the substrate W carried out under the cleaning conditions 2, there may exist a specific point in the cleaning area 30 at which the rotational speed of the substrate W is equal to the rotational speed of the roll cleaning member 16, and the substrate W and the roll cleaning member 16 are rotating in the same direction, i.e., at which the relative speed between them is zero. When the diameter of a circle on the surface of the substrate, lying around the rotational axis O_{W} of the substrate W as the center and passing the specific point, is represented by D₂, the diameter D₂ is smaller than the diameter D₁ of the above-described circle that passes a specific point at which the relative speed is zero under the cleaning conditions 1 (D₂<D₁). Contamination will occur partly in the roll cleaning member 16 in a contaminated area P₂ lying in a position corresponding to the specific point, at which the relative speed is zero, and its vicinity in the cleaning area 30. The contaminated area P₂ lies inside (nearer to the rotational axis O_{W} of the substrate W) the above-described contaminated area P₁ observed under the cleaning conditions 1.

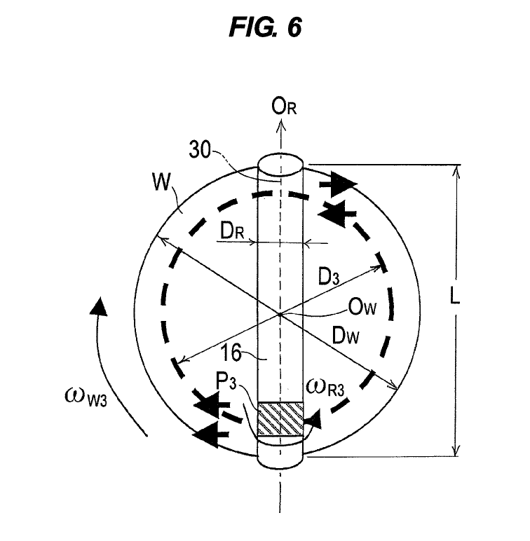

When the surface of the substrate W is cleaned while rotating the substrate W at a rotational speed N_{W3}(<N_{W1}) (angular velocity ω_{W3}(<ω_{W1})) which is lower than the rotational speed N_{W1} (angular velocity ω_{W1}) of the cleaning conditions 1, and/or rotating the roll cleaning member 16 at a rotational speed N_{R3}(>N_{R1}) (angular velocity ω_{R3}(>ω_{R1})) which is higher than the rotational speed N_{R1} (angular velocity ω_{R1}) of the cleaning conditions 1, as shown in FIG. 6, under otherwise the same conditions as the cleaning conditions 1, this cleaning conditions are referred to as “cleaning conditions 3”.

In scrub cleaning of the surface of the substrate W carried out under the cleaning conditions 3, there may exist a specific point in the cleaning area 30 at which the rotational speed of the substrate W is equal to the rotational speed of the roll cleaning member 16, and the substrate W and the roll cleaning member 16 are rotating in the same direction, i.e., at which the relative speed between them is zero. When the diameter of a circle on the surface of the substrate, lying around the rotational axis O_{W} of the substrate W as the center and passing the specific point, is represented by D₃, the diameter D₃ is larger than the diameter D₁ of the above-described circle that passes a specific point at which the relative speed is zero under the cleaning conditions 1 (D₃>D₁). Contamination will occur partly in the roll cleaning member 16 in a contaminated area P₃ lying in a position corresponding to the specific point, at which the relative speed is zero, and its vicinity in the cleaning area 30. The contaminated area P₃ lies outside (nearer to the periphery of the substrate W) the above-described contaminated area P₁ observed under the cleaning conditions 1.

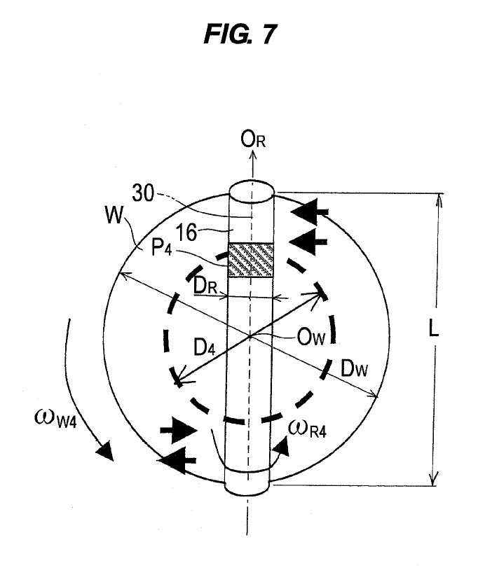

When the surface of the substrate W is cleaned while rotating the substrate W at a rotational speed N_{W4}(=N_{W1}) (angular velocity ω_{W4}(=ω_{W1})) which is equal to the rotational speed N_{W1} (angular velocity ω_{W1}) of the cleaning conditions 1, but in the opposite direction, as shown in FIG. 7, under otherwise the same conditions as the cleaning conditions 1, this cleaning conditions are referred to as “cleaning conditions 4”.

In scrub cleaning of the surface of the substrate W carried out under the cleaning conditions 4, there may exist a specific point in the cleaning area 30 at which the rotational speed of the substrate W is equal to the rotational speed of the roll cleaning member 16, and the substrate W and the roll cleaning member 16 are rotating in the same direction, i.e., at which the relative speed between them is zero. When the diameter of a circle on the surface of the substrate, lying around the rotational axis O_{W} of the substrate W as the center and passing the specific point, is represented by D₄, the diameter D₄ is equal to the diameter D₁ of the above-described circle that passes a specific point at which the relative speed is zero under the cleaning conditions 1 (D₄=D₁). Contamination will occur partly in the roll cleaning member 16 in a contaminated area P₄ lying in a position corresponding to the specific point, at which the relative speed is zero, and its vicinity in the cleaning area 30. The contaminated area P₄ lies in a position which is symmetrical, with respect to the rotational axis O_{W} of the substrate W, to the position of the above-described contaminated area P₁ observed under the cleaning conditions 1.

A substrate cleaning method according to a first embodiment of the present invention, carried out by using the scrub cleaning apparatus shown in FIG. 3, will now be described.

First, the surface of the substrate W is scrubbed and cleaned with the roll cleaning member 16 in the presence of a cleaning liquid while rotating the substrate W and the roll cleaning member 16 under the cleaning conditions 1 (substrate rotational speed N_{W1}, roll cleaning member rotational speed N_{R1}). During the scrub cleaning, the rotational speed of at least one of the substrate W and the roll cleaning member 16 is changed to change the cleaning conditions 1 to the cleaning conditions 2 (substrate rotational speed N_{W2}, roll cleaning member rotational speed N_{R2}) or to the cleaning conditions 3 (substrate rotational speed N_{W3}, roll cleaning member rotational speed N_{R3}). Alternatively, during the scrub cleaning, the direction of rotation of the substrate W is reversed, without changing the rotational speed of the substrate W, to change the cleaning conditions 1 to the cleaning conditions 4.

When the cleaning conditions 1 are changed to the cleaning conditions 2, the contaminated area P₂ of the roll cleaning member 16 comes to appear at a position inside (nearer to the rotational axis O_{W} of the substrate W) the position of the contaminated area P₁ which has existed during cleaning of the surface of the substrate under the cleaning conditions 1, as shown in FIGS. 4 and 5. When the cleaning conditions 1 are changed to the cleaning conditions 3, the contaminated area P₃ of the roll cleaning member 16 comes to appear at a position outside (nearer to the periphery of the substrate W) the position of the contaminated area P₁ which has existed during cleaning of the surface of the substrate under the cleaning conditions 1, as shown in FIGS. 4 and 6. This can reduce concentration of contamination in a particular area of the roll cleaning member 16 and thereby reduce reverse contamination of the substrate W from the roll cleaning member 16, making it possible to clean the surface of the substrate W more uniformly over the entire surface.

When the cleaning conditions 1 are changed to the cleaning conditions 4, the contaminated area P₄ of the roll cleaning member 16 comes to appear at a position which is symmetrical, with respect to the rotational axis O_{W} of the substrate W, to the position of the contaminated area P₁ which has existed during cleaning of the surface of the substrate under the cleaning conditions 1, as shown in FIGS. 4 and 7. This also can reduce concentration of contamination in a particular area of the roll cleaning member 16. The cleaning conditions 1 and the cleaning conditions 4 only differ in the direction of rotation of the substrate W, and are otherwise the same. The cleaning performance is therefore the same between the cleaning conditions 1 and 4. Thus, the change from the cleaning conditions 1 to the cleaning conditions 4 can prevent a lowering of the cleaning performance.

Though the change of the rotational speed of at least one of the substrate W and the roll cleaning member 16 or the change of the direction of rotation of the substrate W may be made at any time during scrub cleaning of the substrate W, such change is preferably made immediately before the end of scrub cleaning of the substrate W. The expression “immediately before the end of scrub cleaning of the substrate W” herein refers to, e.g., a point when about 90 percent of the processing time required for scrub cleaning of the surface of the substrate has elapsed. Thus, for example, when it takes 30 seconds to clean a surface of a substrate, the point is when about 27 seconds have elapsed since the start of cleaning.

By thus changing the rotational speed of at least one of the substrate W and the roll cleaning member 16 or the direction of rotation of the substrate W immediately before the end of scrub cleaning of the substrate W, the surface of the substrate W can be scrubbed and cleaned for a long time under optimal cleaning conditions while reducing concentrated contamination in a particular area of the roll cleaning member 16.

When the rotational speed of at least one of the substrate W and the roll cleaning member 16 is changed, the change may be made either stepwise or continuously. By stepwise changing the rotational speed of at least one of the substrate W and the roll cleaning member 16, cleaning conditions can be set easily, and the rotational speeds of the substrate W and the roll cleaning member 16 can be easily controlled. By continuously changing the rotational speed of at least one of the substrate W and the roll cleaning member 16, on the other hand, a contaminated area in the roll cleaning member 16 can be more uniformly dispersed.

The rotational speed of the substrate W and the rotational speed of the roll cleaning member 16 may be changed simultaneously during scrub cleaning of the surface of the substrate. The optimal combination of the rotational speed of the substrate W and the rotational speed of the roll cleaning member 16 may be selected according to the cleaning conditions, etc. in order to maintain the optimal cleaning performance.

A substrate cleaning method according to a second embodiment of the present invention, carried out by using the scrub cleaning apparatus shown in FIG. 3, will now be described. In this embodiment, the above-described cleaning conditions 1 are used as a forward-direction cleaning step of cleaning a surface of a substrate and the above-described cleaning conditions 4 are used as an opposite-direction cleaning step of cleaning a surface of a substrate. In this embodiment, the forward-direction cleaning step under the cleaning conditions 1 and the opposite-direction cleaning step under the cleaning conditions 4 are alternately repeated for every arbitrary number of successive substrates, for example for every substrate.

In particular, a substrate, which has been carried into the scrub cleaning apparatus, is subjected to the forward-direction cleaning step (cleaning conditions 1) to clean a surface of the substrate. The substrate after cleaning is carried out of the scrub cleaning apparatus, while the next substrate is carried into the scrub cleaning apparatus and is subjected to the opposite-direction cleaning step (cleaning conditions 4) to clean a surface of the substrate. In this manner, the forward-direction cleaning step (cleaning conditions 1) and the opposite-direction cleaning step (cleaning conditions 4) are alternately repeated for every substrate that has been carried into the scrub cleaning apparatus.

As described above, the cleaning conditions 1 and the cleaning conditions 4 only differ in the direction of rotation of a substrate W, and are otherwise the same. The cleaning performance is therefore the same between the cleaning conditions 1 and 4. Therefore, by alternately repeating the forward-direction cleaning step (cleaning conditions 1) and the opposite-direction cleaning step (cleaning conditions 4), e.g., for every substrate, it becomes possible to reduce concentration of contamination in a particular area of the roll cleaning member 16 while maintaining a constant cleaning performance for all the substrates.

The forward-direction cleaning step (cleaning conditions 1) and the opposite-direction cleaning step (cleaning conditions 4) may be alternately repeated for every one-lot successive substrates. This can simplify the control software.

The forward-direction cleaning step (cleaning conditions 1) and the opposite-direction cleaning step (cleaning conditions 4) may be alternately repeated for every predetermined number of successive substrates. The number of substrates for which the forward-direction or opposite-direction cleaning step is repeated successively can be determined, e.g., based on contamination of the roll cleaning member 16. Thus, the flexibility of the cleaning method can be enhanced.

### EXAMPLES 1 AND 2

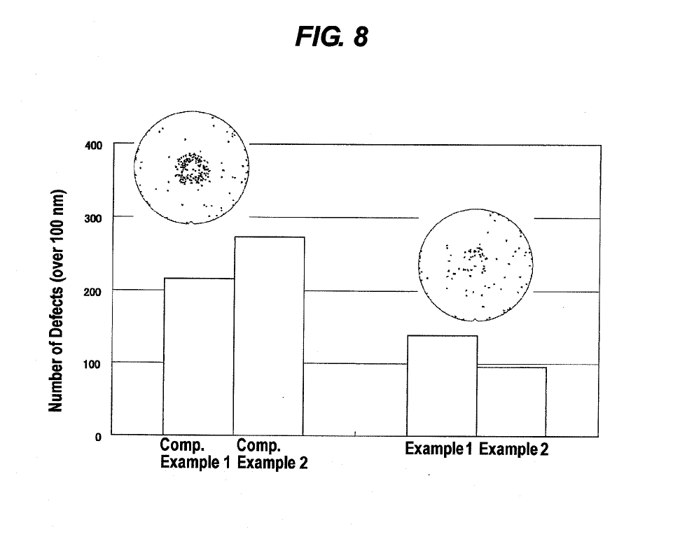

A surface of a TEOS blanket wafer (substrate), having a diameter of 300 mm and a film thickness of 1000 nm, was polished for 60 seconds to prepare a sample. Using the scrub cleaning apparatus shown in FIG. 3, including the roll cleaning member 16 having a diameter of 60 mm, the surface of the sample was cleaned for 28 seconds under the following conditions: the rotational speed of the sample was 150 rpm; the rotational speed of the roll cleaning member 16 was 200 rpm; and the contact pressure between the sample and the roll cleaning member 16 was 4N. Thereafter, only the rotational speed of the roll cleaning member 16 was changed from 200 rpm to 50 rpm, and the surface of the samples was further cleaned under otherwise the same conditions for 2 seconds, followed by spin-drying of the sample. The sample after drying was subjected to measurement of the number of particles (defects), having a size of not less than 100 nm, remaining on the surface of the sample. The results of measurement, together with the distribution of particles (defects) on the surface of the sample, are shown in FIG. 8 (Example 1). Further, the same experiment was repeated by using the same wafer sample (Example 2).

### COMPARATIVE EXAMPLES 1 AND 2

The same sample was cleaned by using the same scrub cleaning apparatus for 30 seconds under the following conditions: the rotational speed of the sample was 150 rpm; the rotational speed of the roll cleaning member 16 was 200 rpm; and the contact pressure between the sample and the roll cleaning member 16 was 4N, followed by spin-drying of the sample. The sample after drying was subjected to the same measurement as in Examples 1 and 2. The results of measurement, together with the distribution of particles (defects) on the surface of the surface, are shown in FIG. 8 (Comp. Example 1). Further, the same experiment was repeated by using the same wafer sample (Comp. Example 2).

As will be appreciated from comparison of the data between the Examples and the Comparative Examples, the cleaning method of the present invention can considerably reduce the number of particles (defects) remaining on the surface of the sample after cleaning and, in addition, can make the distribution of particles (defects) more uniform. The comparative data thus demonstrates a significant enhancement of cleaning performance achieved by the present invention.

While the present invention has been described with reference to preferred embodiments, it is understood that the present invention is not limited to the embodiments described above, but is capable of various changes and modifications within the scope of the inventive concept as expressed herein.

What is claimed is:

1. A substrate cleaning method for scrubbing a surface of a substrate with a roll cleaning member, extending along the diametrical direction of the substrate, by rotating the substrate and the roll cleaning member while keeping the roll cleaning member in contact with the surface of the substrate, said method comprising:
changing a rotational speed of at least one of the substrate and the roll cleaning member or a direction of rotation of the substrate during the scrub cleaning of the surface of the substrate.

2. The substrate cleaning method according to claim 1, wherein the rotational speed of at least one of the substrate and the roll cleaning member or the direction of rotation of the substrate is changed immediately before the end of scrub cleaning of the surface of the substrate.

3. The substrate cleaning method according to claim 1, wherein the rotational speed of at least one of the substrate and the roll cleaning member is changed stepwise or continuously.

4. The substrate cleaning method according to claim 2, wherein the rotational speed of at least one of the substrate and the roll cleaning member is changed stepwise or continuously.

5. The substrate cleaning method according to claim 1, wherein the rotational speed of the substrate and the rotational speed of the roll cleaning member are changed simultaneously during the scrub cleaning of the surface of the substrate.

6. A substrate cleaning method for scrubbing a surface of a substrate with a roll cleaning member, extending along the diametrical direction of the substrate, by rotating the substrate and the roll cleaning member while keeping the roll cleaning member in contact with the surface of the substrate, said method comprising:
a forward-direction cleaning step of scrubbing a surface of a substrate while rotating the substrate in a forward direction; and
an opposite-direction cleaning step of scrubbing a surface of another substrate while rotating the substrate in the opposite direction from the forward direction and at the same rotational speed as in the forward-direction cleaning step,
wherein the forward-direction cleaning step and the opposite-direction cleaning step are carried out in an alternate manner and each is repeated for every arbitrary number of successive substrates.

7. The substrate cleaning method according to claim 6, wherein the every arbitrary number of successive substrates is every substrate, every one-lot successive substrates, or every predetermined number of successive substrates.
